(19) United States
(12) Patent Application Publication
(10) Pub. No.: US 2013/0129066 A1
(43) Pub. Date: May 23, 2013

(54) SYSTEM FOR AND METHOD OF PROVIDING LATA INFORMATION IN RESPONSE TO A LNP QUERY

(71) Applicants: Wing-Cheong Yeung, San Ramon, CA (US); Robin Clair, Flower Mound, TX (US)

(72) Inventors: Wing-Cheong Yeung, San Ramon, CA (US); Robin Clair, Flower Mound, TX (US)

(73) Assignees: CELLCO PARTNERSHIP D/B/A VERIZON WIRELESS, Basking Ridge, NJ (US); VERIZON PATENT AND LICENSING, INC., Basking Ridge, NJ (US)

(21) Appl. No.: 13/300,736

(22) Filed: Nov. 21, 2011

(51) Int. Cl. H04M 3/42

(52) U.S. Cl. 379/211.01

(57) ABSTRACT

A system for and method of providing additional routing information in response to a query to determine whether a dialed number is ported or not. Many customers change service providers and yet keep the same phone number. Thus, whenever a call is made, a service provider may determine whether the dialed number has been ported. This determination may be made via a local number portability (LNP) query to a database. An embodiment of the present invention provides additional information in a LNP query response that assists in routing the call. For example, the LNP response may include a local access transport area (LATA) identifier. The LATA identifier represents a geographic section of the United States and provides routing information. The LATA identifier may be processed to determine the proper routing information for a dialed number. By using LATA identifiers, a more manageable database size may be realized.

### BACKGROUND INFORMATION

Local Number Portability (LNP) allows a user to keep the same telephone number whenever the user makes changes to his or her service provider. Calls that would be directed to the user's previous service provider may then be directed to the user's new service provider. Nationwide LNP databases are established to constantly update the LNP information to support the LNP service. The LNP databases contain routing data including information from Telcordia Local Exchange Routing Guide (LERG) and Number Portability Administration Center (NPAC) data and other routing information. To determine whether a dialed number is ported or not, each carrier performs an LNP database query to determine how to route the call. Thus, to properly route calls, a service provider is required to determine whether a dialed number has been ported or not ported. If the called party number is not ported, an originating network will route a call to a destination network using the information from the LERG table to identify the destination switch/exchange. If the called party number is ported, the LNP query returns a Location Routing Number (LRN) from the NPAC database in terms of NPA-NXX, e.g., 214666, is directed to a destination service provider. Depending on the routing architecture of the destination network, the LRN may denote the routing to the specific destination switch, or the routing aggregation of the destination carrier in conjunction the LERG table and/or other means to route the called party.

### BRIEF DESCRIPTION OF THE DRAWINGS

The present invention, together with further objects and advantages, may best be understood by reference to the following description taken in conjunction with the accompanying drawings, in the several figures of which like reference numerals identify like elements, and in which:

FIG. 1 is a schematic diagram illustrating a system according to a particular embodiment;

FIG. 2 is a block diagram of a hardware components of the system of a particular embodiment;

FIG. 3 is a schematic diagram illustrating a system according to a particular embodiment;

FIG. 4 is an illustration of a query and a query response according to a particular embodiment; and

FIG. 5 is a flowchart illustrating the functionality of a particular embodiment.

### DETAILED DESCRIPTION OF PREFERRED EMBODIMENTS

A system and method may include various embodiments for providing additional information in response to a query, more specifically to a LNP query, to determine whether a dialed number is ported or not. Local number portability may be provided to establish a session between an origination user agent and a destination user agent over one or more networks, such as packet-switched networks, Internet Protocol (“IP”) networks and other networks. For example, an individual may desire to place a call to a friend. The individual may dial a telephone number corresponding to a phone, such as a cell phone, IP phone, etc. The individual's service provider may determine that the dialed number was ported and, instead of directing the call to the friend's old service provider, may direct the call to that person's new service provider. For example, the new service provider may map the number to a dynamic IP address, or any other type of identifier, if necessary to route the call to the person's IP phone. As is well known, communication over an IP network may be by Internet protocol version 4 (“IPv4”) or Internet protocol version 6 (“IPv6”). Other IP versions may be used as well. Any other type of network, such as a public switch telephone network (“PSTN”), may also be used, as described herein.

In various embodiments, local number portability may allow one identifier (e.g., telephone number) to be used regardless of a user's service provider. Local number portability may refer to a telecommunication service that offers, for example, service provider portability, service portability, and/or location portability. Service provider portability may give users the ability to obtain service from any service provider, while retaining the same telephone number. Service portability may allow users to obtain any available telecommunication services, while retaining their number. Location portability may permit users to retain their telephone number when they relocate to a new location. Thus, users experience a seamless transition of a telephone number across multiple carrier networks without a change in the number.

Many customers change service providers and yet keep the same phone number. Thus, whenever a call is made, a service provider may determine whether the dialed number has been ported. This determination may be made via a local number portability (LNP) query to a database. An embodiment of the present invention provides additional information in a LNP query response that assists in routing the call. Specifically, an embodiment of the present invention provides a local access transport area (LATA) identifier with the LNP response. Because the LNP query response may include call routing information and LATA information, the network can use this information to optimize routing. According to another exemplary application, the LATA information included in the LNP query response may be used to optimize network design for call routing to long haul wholesale telecom carriers. In the case of routing call using LNP query to a long haul wholesale carrier, a Session Router maintains the LATA information in its database and thus shrinks the database from over 130,000 entries of LERG NPA-NXX data to approximately 200 LATA data entries according to an embodiment of the present invention. For example, the Session Router may use the LATA information provided in the LNP query response to identify the routing aggregation of the destination carrier.

The Telcordia LERG data contains the Local Access Transport Area (LATA) information. The LATA identifier may be represented by a 3 or 5 digit number which represents a geographic section of a region. The LATA information is mainly for rating purposes. For example, many VoIP carriers use LATA information for call rating purpose. According to an embodiment of the present invention, the LATA identifier may be used for routing a call. Because the LATA identifier represents a geographic section of a region, an embodiment of the present invention may use or process the LATA identifier to determine the proper routing information for a dialed number. For example, each LATA identifier may be associated with a specific switching center. An embodiment of the present invention utilizes a LATA identifier, instead of NPA-NXX numbers to determine routing information. By using LATA identifiers, a more manageable database size may be realized.

The description below describes communication modules, determination modules, routing modules, user agents, service portals, service providers, computer systems, and networks that may include one or more modules, some of which are explicitly shown while others are not. As used herein, the term “module” may be understood to refer to computing software, firmware, hardware, and/or various combinations thereof It is noted that the modules are examples. The modules may be combined, integrated, separated, and/or duplicated to support various applications. Also, a function described herein as being performed at a particular module may be performed at one or more other modules and/or by one or more other devices instead of or in addition to the function performed at the particular module. Further, the modules may be implemented across multiple devices and/or other components local or remote to one another. Additionally, the modules may be moved from one device and added to another device, and/or may be included in both devices.

It is further noted that software described herein may be tangibly embodied in one or more physical media, such as, but not limited to, a compact disc (“CD”), a digital versatile disc (“DVD”), a floppy disk, a hard drive, read only memory (“ROM”), random access memory (“RAM”), as well as other physical media capable of storing software, and/or combinations thereof. The functions described as being performed at various components may be performed at other components, and the various components may be combined and/or separated. Other modifications also may be made.

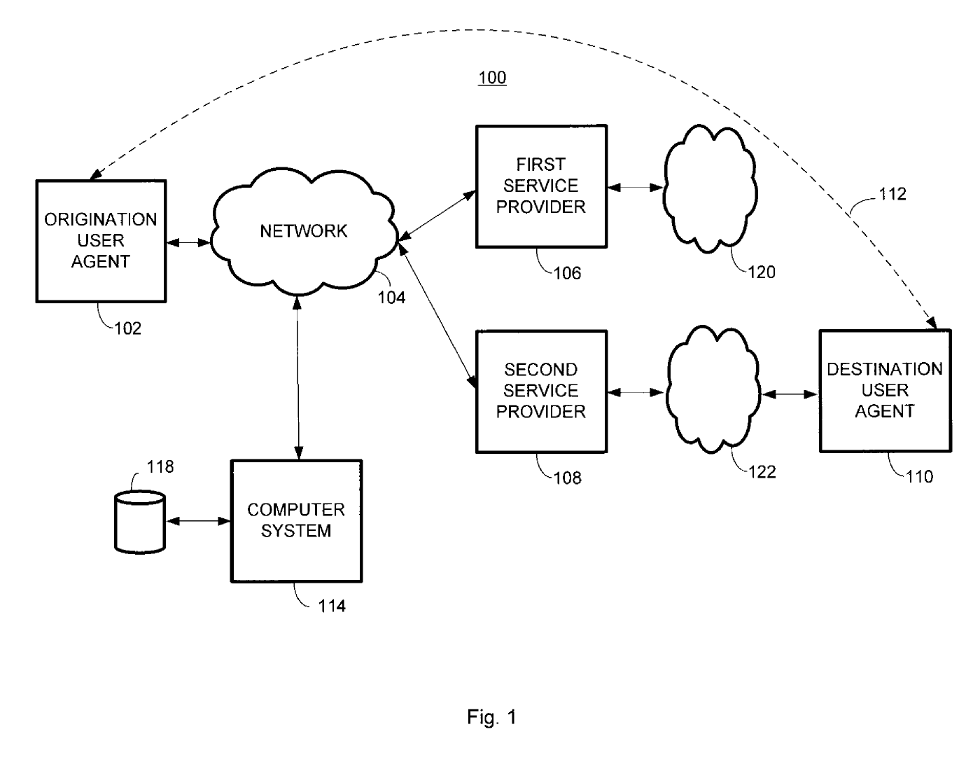

FIG. 1 is a schematic diagram illustrating a system according to a particular embodiment. A system 100 may include an origination user agent 102, a network 104, a first service provider 106, a second service provider 108, a destination user agent 110, a computer system 114, a data storage 118, a network 120, and/or a network 122. Although elements of system 100 may be described as a single device, it will be appreciated that multiple instances of these devices may be included in system 100, such as, for example, multiple user agents, multiple service providers, multiple computer systems, and multiple networks. A user may be associated with origination user agent 102 and another user may be associated with destination user agent 110. The user associated with origination user agent 102, for example, may desire to make a call to the user associated with destination user agent 110.

Origination user agent 102 and/or destination user agent 110 may each be, for example, but not limited to, a cellular telephone, Session Initiation Protocol (“SIP”) phone, software client/phone, a desktop computer, a laptop/notebook, a server, a module, a telephone, a satellite phone, or a communication device, such as a personal digital assistant (“PDA”), a mobile phone, a smart phone, a remote controller, a personal computer (“PC”), a workstation, a mobile device, a phone, a handheld PC, a handheld MP3 player, a handheld video player, a personal media player, a gaming device, a thin system, a fat system, a network appliance, and/or other mobile communication device that may be capable of transmitting and/or receiving data. Also, origination user agent 102 and/or destination user agent 110 may include one or more transmitters, receivers, and/or transceivers to transmit and/or receive one or more signals to and/or from other components depicted in FIG. 1, including, for example, computer system 114, first service provider 106, and/or second service provider 108.

Networks 104, 120, and 122 may each be a wireless network, a wired network, or any combination of wireless network and wired network. For example, networks 104, 120, and 122 may include one or more of a fiber optics network, a passive optical network, a cable network, an Internet network, a satellite network (e.g., operating in Band C, Band Ku or Band Ka), a wireless LAN, a Global System for Mobile Communication (“GSM”), a Personal Communication Service (“PCS”), a Personal Area Network (“PAN”), D-AMPS, Wi-Fi, Fixed Wireless Data, IEEE 802.11a, 802.11b, 802.15.1, 802.11n and 802.11g or any other wired or wireless network for transmitting and/or receiving a data signal. In addition, networks 104, 120, and 122 may include, without limitation, telephone line, fiber optics, IEEE Ethernet 802.3, a wide area network (“WAN”), a local area network (“LAN”), or a global network such as the Internet. Also, networks 104, 120, and 122 may support, an Internet network, a wireless communication network, a cellular network, or the like, or any combination thereof. Networks 104, 120, and 122 may further include one, or any number of the exemplary types of networks mentioned above operating as a stand-alone network or in cooperation with each other. Networks 104, 120, and 122 may utilize one or more protocols of one or more network elements to which it is communicatively coupled. Networks 104, 120, and 122 may translate to or from other protocols to one or more protocols of network devices. Although networks 104, 120, and 122 are each depicted as one network, it should be appreciated that according to one or more embodiments, networks 104, 120, and 122 may comprise a plurality of interconnected networks, such as, for example, a service provider network, the Internet, a broadcaster's network, a cable television network, corporate networks, and home networks.

The components depicted in FIG. 1 may transmit and receive data to and from networks 104, 120, and 122 representing broadcast content, user request content, parallel search queries, parallel search responses, and other data. The data may be transmitted and received utilizing a standard telecommunications protocol or a standard networking protocol. For example, one embodiment may utilize Session Initiation Protocol (“SIP”). In other embodiments, the data may be transmitted and/or received utilizing other Voice Over IP (“VOIP”) or messaging protocols. For example, data may also be transmitted and/or received using Wireless Application Protocol (“WAP”), Multimedia Messaging Service (“MMS”), Enhanced Messaging Service (“EMS”), Short Message Service (“SMS”), Global System for Mobile Communications (“GSM”) based systems, Code Division Multiple Access (“CDMA”) based systems, Transmission Control Protocol/Internet (“TCP/IP”) Protocols, or other protocols and systems suitable for transmitting and receiving broadcast or parallel search data. Data may be transmitted and received wirelessly or may utilize cabled network or telecom connections such as an Ethernet RJ45/Category 5 Ethernet connection, a fiber connection, a traditional phone wireline connection, a cable connection or other wired network connection. Networks 104, 120, and 122 may use standard wireless protocols including IEEE 802.11a, 802.11b and 802.11g. Networks 104, 120, and 122 may also use protocols for a wired connection, such as an IEEE Ethernet 802.3.

The components depicted in FIG. 1 may also be connected to networks 104, 120, and 122, and each other, by one or more service portals (not shown), which may be, for example, but not limited to, a cellular telephone network signal tower, an Internet service provider router, a telephone adapter, a telephone router, an Ethernet router, a satellite router, a fiber optic router, a co-axial cable router, an Internet router, and/or other routing device that may provide and/or determine a transmission path for data to travel. Such service portals may also include a computer, software, and/or hardware to facilitate a routing and/or forwarding function of a signal.

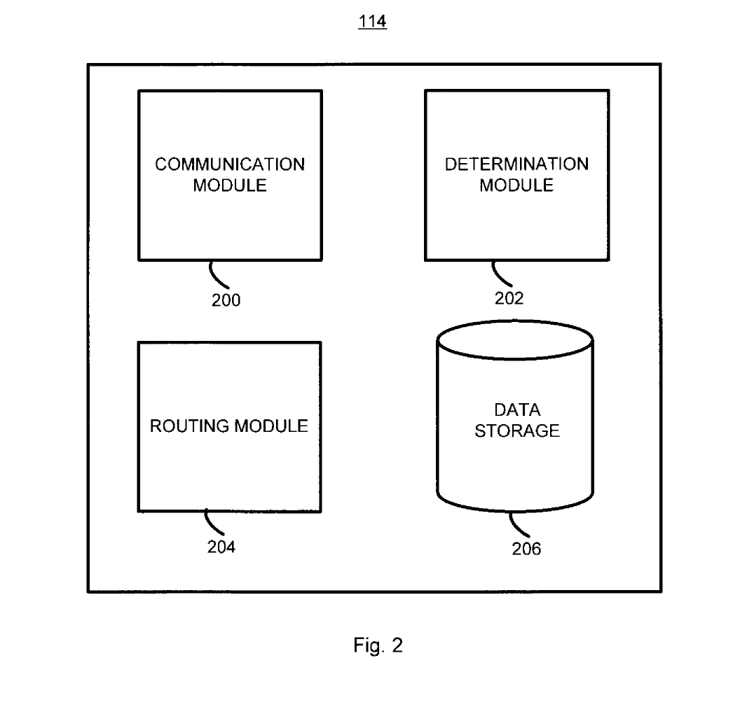

Computer system 114 may include one or more devices, modules, and/or components for providing routing information for transmitting data over a network, such as, for example, an IP network and/or a PSTN. For example, computer system 114 may be part of, or communicatively coupled to, the service provider of the user associated with origination user agent 102, and may receive a request to provide routing information for establishing a call between original user agent 102 and destination user agent 110. Computer system 114 may include one or more computer systems and/or processors to provide routing services. Computer system 114 may include a communication module, a determination module, and a routing module, as described herein in reference to FIG. 2. Computer system 114 may include, or be communicatively coupled to, data storage 118 for providing routing services. Also, in various embodiments, computer system 114 may be a resolution server or may be a module of, or communicatively coupled to, a Domain Name System (“DNS”) server, such as a BIND server, for converting host names and domain names into IP addresses over the Internet.

Computer system 114 may also include one or more devices, modules, and/or components for providing network service for establishing and/or completing a session (e.g., a call) over a network. Computer system 114 may include, for example, computing software, firmware, and/or hardware for supporting SIP. In various embodiments, computer system 114 may be one or more Network Server/Redirect Servers (NS/RS), which may be included together or communicatively coupled to each other. Computer system 116 may also support the authentication and/or registration of user agents over a network (e.g., by receiving and/or providing presence information). Computer system 116 may further include or be communicatively coupled to data storage 118 for providing network services.

Data storage 118 may be network accessible storage and may be local, remote, or a combination thereof to the components depicted in FIG. 1. Data storage 118 may utilize a redundant array of inexpensive disks (“RAID”), tape, disk, a storage area network (“SAN”), an internet small computer systems interface (“iSCSI”) SAN, a Fibre Channel SAN, a common Internet File System (“CIFS”), network attached storage (“NAS”), a network file system (“NFS”), or other computer accessible storage. In one or more embodiments, data storage 118 may be a database, such as an Oracle database, a Microsoft SQL Server database, a DB2 database, a MySQL database, a Sybase database, an object oriented database, a hierarchical database, or other database. Data storage 118 may utilize flat file structures for storage of data. Data storage 118 may be communicatively coupled to computer system 114 or to any other component depicted in FIG. 1. Any of the other components depicted in FIG. 1 may include one or more data storages as well.

First service provider 106 and second service provider 108 may include one or more devices, modules, and/or components for recording, transmitting, routing, receiving, and/or storing data over a network, such as, for example, an IP network and/or a PSTN. For example, first service provider 106 may be the cellular telephone carrier of the user associated with destination user agent 110. Each of first service provider 106 and second service provider 108 may be responsible for a set of identifiers (e.g., telephone numbers) and may administer one or more networks. As depicted in FIG. 1, first service provider 106 may administer network 120 and second service provider 108 may administer network 122. Although first service provider 106 and second service provider 108 are depicted as individual elements in FIG. 1, it should be appreciated that the contents of first service provider 106 and second service provider 108 may be combined into fewer or greater numbers of devices and may be connected to additional devices not depicted in FIG. 1. Furthermore, the one or more devices may be local, remote, or a combination thereof.

FIG. 2 is a block diagram of a hardware component of the system of a particular embodiment. For example, computer system 114 may include a communication module 202, a determination module 202, and a routing module 204. It is noted that modules 200, 202, and 204 are examples and the functions performed by one or more of the modules may be combined with that performed by other modules. The functions described herein as being performed by modules 200, 202, and 204 may also be separated and may be performed by other modules at devices local or remote to computer system 114. The modules may each be a computer program or an appropriately programmed computer, such as a mainframe or personal computer, or may include a plurality of such computers cooperating to perform the functionality described herein. Modules 200, 202, and 204 may also communicate with data storage 206. Modules 200, 202, and 204 may also be coupled to or integrated with computer system 114. For example, modules 200, 202, and 204 may be external devices that are wirelessly coupled and/or communicatively coupled to computer system 114 via an interface port which may include, without limitation, USB ports, system bus ports, or Firewire ports and other interface ports. Further, computer code may be installed on computer system 114 to control and/or operate a function of communication module 200, determination module 202, and/or routing module 204.

It is well known that users may want to switch service providers for various reasons, such as to obtain cheaper or better service. When a user changes service providers, the user's unique identification, such as a telephone number, may be “ported” from the old service provider's network to the new service provider's network. Every call made to the “ported” device (e.g., cellular telephone, IP phone) may then have to be directed to the new service provider's network.

Communication module 200 of computer system 114 may receive a request to establish a session between origination user agent 102 and destination user agent 110. The session may be for communicating voice and/or data. For example, origination user agent 102 may attempt to make a call to destination user agent 110 using an identifier (e.g., telephone number) associated with destination user agent 110 and/or the user associated with destination user agent 110. Doing so may cause a request to be generated and sent to computer system 114. The request may, for example, originate at origination user agent 102, any service portals, and/or any component or device in network 104. The request may include information associated with the desired call, such as an identifier for destination user agent 110 and/or an identifier for origination user agent 102. The request may be a routing request. In various embodiments, the request may be received over an IP network, such as an IPv6 network. For example, origination user agent 102 may be an IPv6 phone and network 104 may include an IPv6 WAN.

The identifier for destination user agent 102 may be in any format. For example and without limitation, it may be a telephone number, an E.164 Number Mapping (“ENUM”) number, a private number, an abbreviated number that translates to a public or private number (e.g., a speed dial number), a Uniform Resource Identifier (“URI”), or any other suitable number, and/or any combination thereof. In various embodiments, the identifier may be a telephone number used to reach an IP device over an IP network. In that case, the telephone number may be used to reach the correct second service provider 108, and second service provider 108 may map that number to a dynamic IP address registered to destination user agent 110 and route the call to destination user agent 110.

The request may also be received as part of normal name resolution. For example, computer system 114 may include a DNS server and may receive a request to convert a host name and domain name for destination user agent 110 into an IP address. Computer system 114 may then use the received host name and domain name to route the session to second service provider 108 and/or determine an IP address (utilizing data storage 206, for example) to reach destination user agent 110. Computer system 114 may also communicate with other computer systems to do so as well.

As depicted in FIG. 2, determination module 202 of computer system 114 may determine that the received identifier was ported from first service provider 106 to second service provider 108. For example, determination module 202 may search data storage 206 or data storage 118 for the dialed number to find the indication, which may associated with the number that was dialed. Data storage 206 and/or data storage 118 may be modified as necessary based on new information received, for example, over network 104.

In various embodiments, local number portability may be achieved by providing routing information for establishing a session (e.g., a call) from origination user agent 102 to destination user agent 110. The routing information may include locations, instructions, and/or other information for reaching second service provider 108 and/or destination user agent 110. For example, second service provider 108 may provide information to computer system 114 to instruct computer system 114 how to appropriately route incoming calls through various networks to reach second service provider 108, and computer system 114 may use that information to create routing information for the session. Once a call reaches second service provider 108, it may map the number to another identifier (e.g., IP address for which destination user agent 110 is currently registered) as necessary to complete the call. Destination user agent 110 may also broadcast information regarding its capabilities, handling information, and/or information regarding what calls should be redirected and when, for example. Computer system 114 may receive such information from second service provider 108 and/or destination user agent 110 (or any other component depicted in FIG. 1) and use that information to create routing information for reaching destination user agent 110 through second service provider 108.

The routing information may also indicate how a call should be completed and/or how a call should be handled. For example, routing information may indicate that a call may be established and data transferred for a call from origination user agent 102 (e.g., an IPv6 phone) to various service portals, to network 104 (e.g., an IPv6 WAN), to other service portals, to second service provider 108, to network 122, and finally to destination user agent 110 (e.g., an IPv6 phone). The routing information may also indicate what destination user agent 110 may require for session connection. The routing information may be stored in data storage 206 and/or data storage 118 for later use as necessary. Or the routing information may be received from any other entity or component (e.g., by querying network 104). The routing information may also comprise an identifier. The determination module 202 may also process the LATA identifier to identify routing information for the dialed number.

As depicted in FIG. 2, routing module 204 of computer system 114 may provide the routing information for establishing the session. For example, the routing information may be provided to various service portals, origination user agent 102, second service provider 108, and/or destination user agent 110 so that a connection may be established between origination user agent 102 and destination user agent. The routing information may be provided to any other entity or component as well. As described herein, an identifier (e.g., telephone number) associated with destination user agent 110 may have been “ported” from first service provider 106 to second service provider 108. Computer system 114 may therefore provide routing information to various service portals so that the call may be appropriately connected through second service provider 108. The routing information may indicate how the call should be routed over one or more networks using different networking protocols. The routing information, for example, may identify service portals corresponding to second service provider 108 and/or destination user agent 110 so that other service portals may route the call through second service provider 108. The routing information may also identify capabilities of destination user agent 110 and/or other components. The routing information may be provided as one or more parameters sent along with other data that may be provided.

Once the routing information is provided, the call may proceed, as shown by a connection 112 depicted in FIG. 1. For example, SIP may be used to set up and tear down the call session between origination user agent 102 and destination user agent 110 and/or to negotiate the capabilities for the session. Real-Time Transport Protocol (“RTP”) may be used to transfer data during the call across one or more IP networks.

In various embodiments, computer system 114 may also act an interpreter for the conversion of identifiers as necessary. Depending on what networks must be traversed to reach second service provider 108 and destination user agent 110, computer system 114 may modify the received identifier's format. For example, in an IPv6 environment, when a telephone number is received, it may be translated to an IPv6 address. It is well known that the addressing schemes of various networks may be different (e.g., 32 bits for IPv4, 128 bits for IPv6). Computer system 114 (or any other component depicted in FIG. 1) may make any conversion necessary for routing data over an IPv4 or IPv6 network.

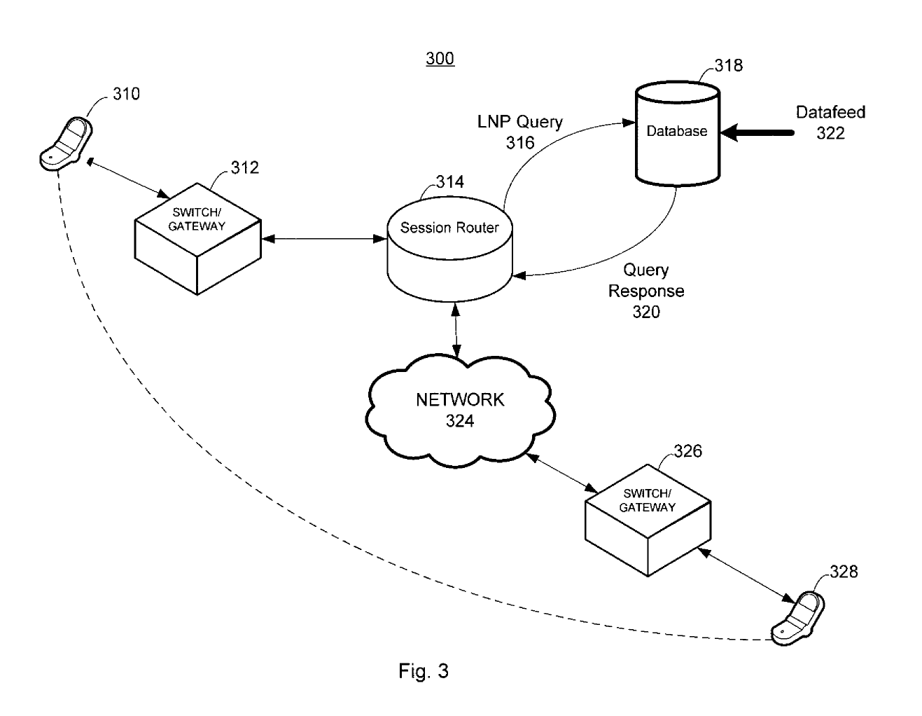

FIG. 3 is a schematic diagram illustrating a system 300 according to a particular embodiment. As shown in FIG. 1, an originator device 310 may place a call to a destination device 328. The originator device may include a telephone, cell phone, computer or other device capable of placing a call. The originator device may dial a number or other identifier associated with the destination device. A common example is a phone number of the destination device. The dialed number may be routed to a switch/gateway 312 and/or one or more other intermediaries. A session router 314 may receive the dialed number and then place a local number portability (LNP) query 316 to a database 318. A number portability check may be performed on the dialed number by querying or otherwise accessing a database. The LNP query 316 may initiate a determination as to whether the dialed number is a ported or a non-ported telephone number.

The database 318 may be a LNP database, which may include a list of telephone numbers that have been ported and corresponding routing information, such as a LRN. When a calling number is dialed, the local telephone exchange may query a database for the LRN associated with the subscriber. By using the LRN, there is no need for the public telephone number to identify a local exchange carrier. Thus, if a subscriber decides to switch telephone service providers, the user may keep his or her current telephone number and only the LRN needs to be change. Accordingly, calls originating from the ported telephone lines or directed to the ported telephone lines may be rerouted. Customers are able to keep their existing telephone numbers while being ported from one carrier to another carrier, or even PSTN to another network, such as VoIP network, IP network or other network.

In addition to the database 318 using the dialed number to perform a number portability check, the database 318 may also perform a domain check. The database may translate a dialed number to a routing number. The routing number may be a physical address, representing a geographical location of a serving switch of the dialed number. The routing number may also identify a called station.

The database 318 may be an ENUM database. ENUM allows a telephone number to be provided, like a world wide website domain name, to an Internet Domain Name Server (DNS). The DNS returns, in response, telephone number related information such as an IP address corresponding to the dialed number. The dialed number may be an E.164 number which may include telephone country code values. The ENUM database may facilitate users moving from location to location since users can update the information in the ENUM database with a temporary IP address so that calls may be directed to the user's current location at any time. In response to entry of a telephone number, the DNS returns information from an ENUM database. The ENUM database may include IP telephony information associated with a particular telephone number. The telephone number associated information may include, e.g., IP address information to be used when routing IP calls to the entered telephone number, an email address and other information relating to or associated with the telephone number or service subscriber assigned to use the telephone number.

Some of the information obtained using ENUM may be the same or similar to information obtained using SIP. The SIP and ENUM databases may include telephone numbers and other information corresponding to multiple parties, e.g., IP telephone device users.

ENUM is a protocol which, like SIP, may be used to provide information relating to a telephone customer's capabilities, preferences, call forwarding settings, etc. In accordance with various embodiments of the present invention, ENUM may be an alternative to, or in conjunction with, SIP as a way for a PSTN based device to obtain called party information from another network, such as an IP network. The called party information obtained using ENUM may be used to make call routing and call completion information in a similar manner that called party information obtained using SIP can be used. Other protocols including SS7 may be also be implemented in a similar manner as discussed in connection with ENUM and SIP. SS7 is a signaling protocol used to exchange information between network elements. A SS7 network and protocol can be used for such services as basic call setup, management and tear down, local number portability (LNP), toll-free service, enhanced call features, efficient and secure worldwide telecommunications, etc.

If the called number is ported, the database 318 may respond with a query response 320, which may include a local routing number (LRN). The LRN may be a 10 digit number, in the format of NPA-NXX-XXXX, that uniquely identifies a switch or point of interconnection (POI) through which multiple telephone numbers are routed. In this format, NPA represents the number plan area, or area code, NXX represents the central office code and XXXX identifies the stations number. The first six digits of the LRN, which may be represented by NPA-NXX, have a geographic relevance and may be associated to a specific switching center. This may be specific to a phone carrier. For example, when a telephone user subscribes to a service provider, the user is assigned to a station number with the NPA-NXX of that central office.

If the called number is not ported, then the database may return the dialed number in the query response 320. In addition, the query response 320 may include an indicator that represents that the dialed number is not ported.

According to an embodiment of the present invention, the query response 320 may include a local access transport area (LATA) identifier. The LATA identifier may be represented by a 3 or 5 digit number. For example, “720” may represent Reno, Nev. The LATA may be an identifier that geographically splits the United States into about 200 geographic sections. A plurality of NPA-NXX identifiers may be associated with a LATA identifier. Other identifiers that represent a geographic section of a larger region may also be used in accordance with the various embodiments of the present invention. For example, a global identifier may represent geographical segments worldwide.

The session router 314 may then use the LRN and domain information along with the LATA to determine a switch or gateway 326 or other intermediary to route the call via network 324. The session router 314 may use a Local Routing Table (LRT) to process the LATA of the dialed number to determine the proper routing information for that call. The call may then proceed to be routed, which may involve routing to a network 324, a switch/gateway 326 and/or one or more other intermediaries and then eventually to the destination 328.

An advantage of an embodiment of the present invention is the ability to provide a more manageable database of identifiers. Currently, each carrier maintains a database of NPA-NXX identifiers for the entire United States. The entries in the database are in the range of 130,000 to 140,000. This same database may be maintained in each network element. In some instances, this may involve many network elements each maintaining the database of over 130,000 entries. By using the LATA information in the query response, each carrier is able to maintain a more manageable database. For instance, LATA identifier, instead of NPA-NXX identifier, may be used to determine a correct trunk group. With the use of LATA identifiers, the database size may be around 200 entries, in contrast to a database of over 130,000.

In addition, NPA-NXX identifiers are constantly changing in that new ranges are added and sometimes old ranges are deleted. In contrast, LATA identifiers are more static and do not change often. Each LATA identifier has an associated plurality of NPA-NXX identifiers. By utilizing LATA identifiers, a database of about 200 entries for routing calls may be efficiently implemented.

The LNP query to obtain the LATA information may be protocol independent. For example, the LNP query may be generated using ENUM, SS7, SIP or other protocols.

The database 318, e.g., LNP database, ENUM database, etc., maintains current ported number routing data. This information may be sent back to a router, switch and/or other intermediary, which routes the call. The database may be updated by a datafeed 322 and/or by a service which periodically downloads information from the Number Portability Administration Center (NPAC). The NPAC may be serve as a clearinghouse for ported number routing information.

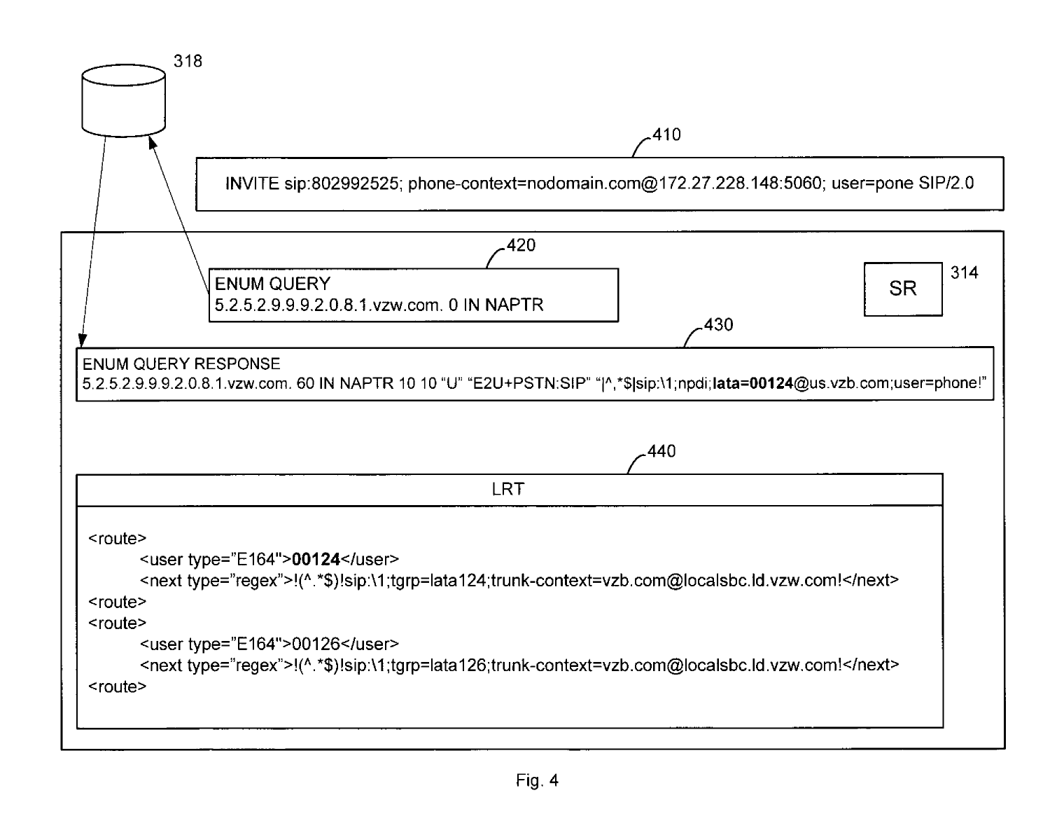

FIG. 4 is an illustration of a query and query response, in accordance with a particular embodiment. In this exemplary illustration, an incoming call 410 may be received from a switch, such as a mobile switch center (MSC). The ENUM query 420 may be sent to the ENUM database 318 which may then return a ENUM query response 430. ENUM query response 430 may include a routing number, e.g., LRN, and a LNP dip indicator. For example, “npdi” may indicate whether a LNP dip has been performed, “@us.vzb.com” may indicate the domain name, “user=phone” may indicate that the destination device is a phone. As shown in response 430, a LATA identifier is included in the response, as shown by “lata=00124.”

A LNP query may be performed in various ways, such as ENUM query, SIP redirect message, and locally hosted number portability database. Other methods for determining whether a number is ported or not may be realized. For a ENUM query, a VoIP platform may send a ENUM query to a number portability database, such as a LNP database. The database may then return a ENUM query response with a routing number and a number portability dip indicator (npdi). For SIP, a VoIP platform may send a SIP INVITE to a number portability database. The database may return a SIP redirect message with a routing number and a number portability dip indicator. For a locally hosted environment, a VoIP platform may query a routing engine where the routing engine hosts a number portability database and performs routing based on the routing number. The routing engine may get periodic updates to the number portability database.

A configurable field may be used to retrieve the LATA value based on the NPA-NXX of the dialed number or the NPA-NXX of the location routing number (LRN), if the dialed number is ported. The ROUTE record may be modified to support a configurable field that may indicate if the LATA field is included in the user parameter when a SIP-URI or TEL-URI is generated. When the ENUM service instance generates a SIP-URI or a TEL-URI from the resolved ROUTE record, the LATA value may be retrieved and included in the user-parameter if the ROUTE record is configured to include the LATA parameter.

The Local Routing Table (LRT) 440 may be used to identify routing information for a particular LATA identifier. The LRT includes routing information associated with each LATA identifier. For example, LATA numbers are shown as “00124” and “00126.” Because an embodiment of the present invention uses LATA identifiers to route the calls, service providers are able to maintain a more manageable database. For instance, LATA identifier, instead of NPA-NXX identifier, may be used to determine a correct trunk group. With the use of LATA identifiers, the database size may be around 200 entries, in contrast to a database of 130,000 to 140,000 entries.

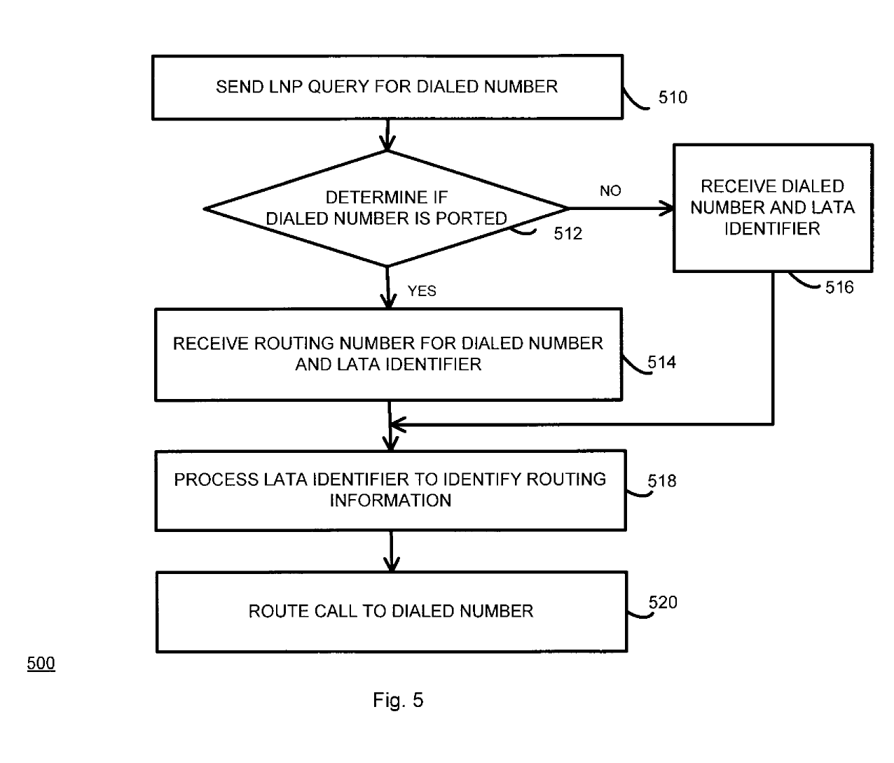

FIG. 5 is a flowchart illustrating the functionality of a particular embodiment. This method is provided by way of example, as there are a variety of ways to carry out the methods described herein. Method 500 shown in FIG. 5 may be executed or otherwise performed by one or a combination of various systems. The method 500 may be carried out through systems 100, 300 of FIG. 1 and FIG. 3 by way of example, and various elements of FIG. 1 and FIG. 3 are referenced in explaining method 500 of FIG. 5. Each block shown in FIG. 5 represents one or more processes, methods, or subroutines carried out in method 500. Method 500 may begin at block 510.

At block 510, a router may send a query to a database. For example, a session router may receive a dialed number and then place a local number portability (LNP) query to a database.

At block 512, in response to the query, a database may determine whether the called number is ported or not. For example, the database may use the dialed number to perform a number portability check. The database may be a LNP database, which may include a list of telephone numbers that have been ported and corresponding routing information, such as a local routing number (LRN). If a user decides to switch telephone service providers, the user may keep his or her current telephone number and only the LRN needs to be change. Thus, customers are able to retain their existing telephone numbers while being ported from one carrier to another carrier, or even PSTN to another network, such as VoIP network, IP network or other network.

The database may be an ENUM database. ENUM allows a telephone number to be provided, like a world wide website domain name, to an Internet Domain Name Server (DNS). The DNS returns, in response, telephone number related information such as an IP address corresponding to the dialed number. The dialed number may be an E.164 number which may include telephone country code values. The ENUM database may facilitate users moving from location to location since users can update the information in the ENUM database with a temporary IP address so that calls may be directed to the user's current location at any time. In response to entry of a telephone number, the DNS returns information from an ENUM database. The ENUM database may include IP telephony information associated with a particular telephone number. The telephone number associated information may include, e.g., IP address information to be used when routing IP calls to the entered telephone number, an email address and other information relating to or associated with the telephone number or service subscriber assigned to use the telephone number.

Some of the information obtained using ENUM may be the same or similar to information obtained using SIP. The SIP and ENUM databases may include telephone numbers and other information corresponding to multiple parties, e.g., IP telephone device users.

Other protocols including SS7 may be also be implemented in a similar manner as discussed in connection with ENUM and SIP. SS7 is a signaling protocol used to exchange information between network elements. A SS7 network and protocol can be used for such services as basic call setup, management and tear down, local number portability (LNP), toll-free service, enhanced call features, efficient and secure worldwide telecommunications, etc.

At block 514, if the dialed number is ported, the database may return a LRN identifier and a LATA identifier. The LRN may be a 10 digit number, in the format of NPA-NXX-XXXX, that uniquely identifies a switch or point of interconnection (POI) through which multiple telephone numbers are routed. The first six digits of the LRN, which may be represented by NPA-NXX, have a geographic relevance and may be associated to a specific switching center. This may be specific to a phone carrier. For example, when a telephone user subscribes to a service provider, the user is assigned to a station number with the NPA-NXX of that central office.

At block 516, if the dialed number is not ported, the database may return the dialed number and a LATA identifier. In addition, the response may include an indicator that represents that the dialed number is not ported.

At block 518, the LATA identifier may be used or processed to determine routing information. The routing information may be provided to a service portal so that the call can be appropriately routed through second service provider rather than first service provider.

The session router may process the LATA identifier to determine one or more a switches, gateways and/or other intermediaries to route the call via one or more networks. The session router may use a Local Routing Table (LRT) to process the LATA of the dialed number to determine the proper routing information for that call. The call may then proceed to be routed, which may involve routing to one or more networks, switches, gateways and/or one or more other intermediaries and then eventually to the destination device.

The LATA identifier may be represented by a 3 or 5 digit number that represents a geographical section of a larger region. For example, the LATA identifiers may correspond to one of 200 geographic sections. A plurality of NPA-NXX identifiers may be associated with a LATA identifier. Other identifiers that represent a geographic region may also be used in accordance with the various embodiments of the present invention.

An advantage of an embodiment of the present invention is the ability to provide a more manageable database of NPA-NXX identifiers. Currently, each carrier maintains a database of NPA-NXX identifiers for the entire United States. The entries in the database are in the range of 130,000 to 140,000. This same database may be maintained in each network element. In some instances, this may involve approximately 44 network elements each maintaining the database of 130,000 to 140,000 entries. By using the LATA information in the query response, each carrier is able to maintain a more manageable database. For instance, LATA identifier, instead of NPA-NXX identifier, may be used to determine a correct trunk group. With the use of LATA identifiers, the database size may be around 200 entries, in contrast to a database of 130,000 to 140,000 entries.

Because NPA-NXX identifiers are constantly changing, many modifications may be required to accommodate new ranges being added and old ranges being deleted. In contrast, LATA identifiers are more static and do not change often. Each LATA identifier has an associated plurality of NPA-NXX identifiers. By utilizing LATA identifiers, an embodiment of the present invention uses a database of about 200 entries for routing calls may be realized.

At block 550, the call may be routed in accordance with the routing information. For example, the routing information may indicate how the call should be routed over one or more networks using different networking protocols. The routing information, for example, may identify service portals corresponding to second service provider and/or destination user agent so that other service portals may route the call through second service provider. The routing information may also identify capabilities of destination user agent and/or other components. The routing information may be provided as one or more parameters sent along with other data that may be provided. Once the routing information is provided, the call may proceed to destination device associated with the dialed number.

After the call is finished, the session may be terminated.

In the preceding specification, various preferred embodiments have been described with references to the accompanying drawings. It will, however, be evident that various modifications and changes may be made thereto, and additional embodiments may be implemented, without departing from the broader scope of invention as set forth in the claims that follow. The specification and drawings are accordingly to be regarded in an illustrative rather than restrictive sense.

1. A method, comprising:
sending a query for a dialed number to a database; wherein the query initiates a determination whether the dialed number is ported or not ported;
receiving a query response in response to the query, wherein the response comprises a local access transport area (LATA) identifier associated with the dialed number;
processing the LATA identifier, using one or more processors, to identify routing information based on the LATA identifier for the dialed number; and
routing the dialed number using the routing information for establishing a session from a origination device to a destination device.

2. The method of claim 1, wherein the query comprises a local number portability (LNP) query.

3. The method of claim 1, further comprising:
if the dialed number is ported, receiving a local routing number (LRN) associated with the dialed number in the query response.

4. The method of claim 1, wherein the LATA identifier represents a geographic section of a region.

5. The method of claim 1, wherein the LATA identifier identifies an intermediary associated with a specific service provider.

6. The method of claim 1, wherein the step of processing further comprises accessing a local routing table to determine the routing information.

7. The method of claim 1, wherein the LNP query is protocol independent.

8. The method of claim 1, wherein the database is a ENUM database, the query is a ENUM query and the response is a ENUM query response.

9. The method of claim 1, wherein the database comprises LATA identifiers, wherein each LATA identifier is associated with a plurality of NPA-NXX identifiers.

10. A computer readable medium comprising code to perform the steps of the methods of claim 1.

11. A computer-based system, comprising:
a communication module configured to send a query for a dialed number to a database; wherein the query initiates a determination whether the dialed number is ported or not ported and receive a query response in response to the query, wherein the response comprises a local access transport area (LATA) identifier associated with the dialed number;
a determination module configured to process the LATA identifier, using one or more processors, to identify routing information based on the LATA identifier for the dialed number; and
a routing module configured to route the dialed number using the routing information for establishing a session from a origination device to a destination device.

12. The system of claim 11, wherein the query comprises a local number portability (LNP) query.

13. The system of claim 11, wherein if the dialed number is ported, the communication module is configured to receive a local routing number (LRN) associated with the dialed number in the query response.

14. The system of claim 11, wherein the LATA identifier represents a geographic section of a region.

15. The system of claim 11, wherein the LATA identifier identifies an intermediary associated with a specific service provider.

16. The system of claim 11, wherein the step of processing further comprises accessing a local routing table to determine the routing information.

17. The system of claim 11, wherein the LNP query is protocol independent.

18. The system of claim 11, wherein the database is a ENUM database, the query is a ENUM query and the response is a ENUM query response.

19. The system of claim 11, wherein the database comprises LATA identifiers, wherein each LATA identifier is associated with a plurality of NPA-NXX identifiers.

20. The system of claim 11, wherein the database comprises a LNP database.
